(19) United States
(12) Patent Application Publication
(10) Pub. No.: US 2004/0022383 A1
(43) Pub. Date: Feb. 5, 2004

(54) Method and system for remote call dialing and answering

(76) Inventors: Daniel Neal Duncan, Austin, TX (US); Louis Madison Ginac, Gainesville, GA (US)

Correspondence Address: Robert W. Holland, Attorney for Applicant(s), HAMILTON & TERRILE, LLP, PO Box 203518, Austin, TX, 78720, US

(21) Appl. No.: 10/210,215

(22) Filed: Aug. 1, 2002

(51) Int. Cl. H04M 3/00; H04M 5/00

(52) U.S. Cl. 379/265.01

(57) ABSTRACT

Remote agents geographically distributed from contact devices connect with contacts of the contact devices through a computer network. A remote agent server coordinates connections between telephone contacts and remote agents by directing the telephone contacts to connect with remote agent computer systems interfaced with a computer telephony integration platform. Contact device resources, such as dialing and answering resources, are allocated through a scheduling graphical user interface to enhance the efficiency of contact device use. In one embodiment, contact resources are assigned on a pay-for-use basis. Contact lists for outbound dialing or to answer predetermined inbound calls are associated with predetermined remote agents with remote agent computer addresses.

### BACKGROUND OF THE INVENTION

1. Field of the Invention

The present invention relates in general to the field of automated telephone dialing and answering systems, and more particularly to a method and system for remote call dialing and answering.

2. Description of the Related Art

Automated telephone outbound dialing and inbound answering systems have provided significant efficiencies in contacting people and in responding to inbound inquiries to calling centers. Outbound predictive dialers provide greater efficiency for placing outbound telephone calls by tracking the progress of a calling campaign for a set of calling agents and placing outbound calls that are transferred to agents as they are answered. The rate at which outbound calls are made is based on predictions of answering rates and agent availability by using calling statistics, such as average call duration. Agent productivity improves dramatically compared with manual dialing since agents are only connected to calls that are answered, reducing agent time spent dealing with answering machines and no answers. Further, caller information is provided to agents through computer displays to allow the agents to quickly address the purpose of the call. Inbound automated call distribution systems provide greater efficiency in responding to inbound calls by forwarding calls to agents as the agents become available. Inbound calls are also selectively forwarded by interactive voice response units that identify the purpose of the calls based on user inputs and forward the calls to selected agents along with caller information provided by computer displays. In some instances, calling centers combine inbound and outbound systems to further improve operator efficiency by having either inbound or outbound call workloads available.

One difficulty with automated telephone inbound dialing and outbound answering systems is that the systems are complex and expensive to use and maintain. For instance, predictive dialers are typically based on proprietary hardware and software designs that use complex algorithms to determine outbound call rates. Technical expertise and manufacturer support are often required, along with frequent upgrades, all of which add to the expense of operating a calling center. Further, agents who use outbound dialing systems are typically tied to the physical location of the system, which typically has a fixed capacity. Thus, opening a calling center or expanding an existing calling center often represents a substantial investment since calling capacity expansion usually entails the purchase of a new dialing system and space for agents. If the capacity needed by a calling center is less than a complete system's capacity, the excess capacity typically goes unused.

One example of how the inflexibility of automated calling and answering systems restricts their use by businesses is the advertisement of a special offer promotion. Interest by callers, either in contacting a business or in talking to agents who initiate contact, tends to be highest at or near the time that the promotion is first brought to the callers' attention. For instance, outbound calling campaigns tend to have a more positive impact when contacted individuals are familiar with the purpose of the call, such as through media advertising targeted by regions. Similarly, a business that advertises a promotion typically expects a surge in interest from inbound callers to occur at or shortly after the time of the advertisement. However, automated dialing and answering systems are typically too expensive to purchase or operate for short-term campaigns. Although businesses may hire calling centers to perform automated dialing and answering services, agent availability, training and quality management often make such services difficult to use.

### SUMMARY OF THE INVENTION

Therefore a need has arisen for a system and method which provides automated call dialing and answering with remote agents who are distributed from the location of the dialing and answering system.

A further need exists for a system and method which provides more efficient use of dialing and answering system capacity.

A further need exists for a system and method which supports automated sharing of dialing resources among multiple users.

In accordance with the present invention, a system and method are provided which substantially reduces the problems and difficulties associated with previous methods for contacting individuals. Geographically distributed remote agents interface with contact devices through a computer network and computer telephony integration platform to handle individual contacts through computer systems. A remote agent server coordinates communication between remote agents and contacts through the computer telephony integration platform and forwards contact information to remote agent computer systems

More specifically, in one embodiment, one or more contact devices are interfaced with a computer telephony integration platform that accepts telephone contacts made through the telephone network and transfers the telephone calls to a computer network, such as a packet-switched computer network that uses Voice over Internet Protocol. The contact devices include predictive dialers that place outbound calls and answering devices, such as automatic call distribution systems, that answer inbound calls. A list manager interfaces with the contact devices to track contact resources, such as lines available for placing and answering calls and scheduled contact device use. As outbound calls are answered by contacted individuals or as inbound calls are answered, the contact devices forward the contact to a computer telephony integration platform which translates the calls for transmission over the computer network to remote agent computer systems.

A remote agent server interfaces with the list manager and the computer telephony integration platform to coordinate the connection of contacts from contact devices with remote agents. For instance, a remote agent scheduling graphical user interface communicates with the list manager through the remote agent server to schedule contact devices and associated remote agents. With an outbound calling campaign, the list manager displays available contact device resources and accepts contact lists for scheduling with one or more outbound dialing contact devices. An individual or business having a calling campaign may be charged based on contact device resource use so that the remote agent server acts as a vendor for outbound dialing services from one or more contact devices. Geographically distributed remote agents are identified, such as with computer IP address information, so that a calling campaign is orchestrated without being tied to a physical location, allowing the calling party to use its own trained remote agents. Remote agents access the list and outbound calls are made by the contact device based on a predictive dialing engine so that contact device resources are scheduled dynamically and invisibly to users. The remote agent server provides contact information associated with contacts through screens presented on remote agent computer systems, such as with HTML pages.

The present invention provides a number of important technical advantages. One example of an important technical advantage is that remote agents communicate through a computer network with contacts generated by contact devices, allowing geographically distributed agents to handle inbound and outbound calls. The remote agent server coordinates the transfer of contacts from contact devices through a computer telephony integration platform to provide seamless connection of contacts and remote agents, such as by connecting remote agents through the Internet. In addition, the remote agent server coordinates the transfer of contact information associated with contacts to remote agents. For instance, voice and data for a contact can be established with an Internet interface with a geographically distributed agent by using Voice over Internet Protocol for voice contact and a server push of contact information.

Another example of an important technical advantage is that contact device resources are used more productively and efficiently. For instance, a business with contact resources needs of less than that provided by purchase of a contact device may use contact resources on a use-pay basis. Thus, calling centers with excess contact resource capacity may lease out capacity to others as available by interfacing the calling center's contact devices with a remote agent server, list manager and computer telephony integration platform. Moreover, remote agents interact with contacts through the Internet, reducing the need for a centralized physical calling location.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for geographically distributed remote agents;

FIG. 2 depicts a block diagram of a computer telephony integration platform;

FIG. 3 depicts a flow diagram of information transferred to perform an outbound calling campaign; and

FIG. 4 depicts a flow diagram for processing call records.

### DETAILED DESCRIPTION

Contact devices, such as predictive dialers and automated answering units, typically represent a substantial capital investment for a given contact resource capacity. Calling centers or businesses that use calling campaigns do not typically have contact needs that match up with contact device capacity, and often leave contact capacity unused. Some calling centers are available to run calling campaigns for businesses, however, the business loses control over the agents assigned to calling capacity and the quality of contacts that are made. The present invention addresses these difficulties by providing scheduling of contact campaigns by businesses through third party vendors in an automated manner. Calling centers that have excess capacity allow access to businesses for scheduling contact campaigns and transferring contacts made from contact devices at a fixed location to remote agents geographically distributed from the contact devices. For instance, businesses schedule contacts for transfer to predetermined geographically distributed remote agents interfaced through computer systems, such as through the Internet using Voice over Internet Protocol, for improved control of the quality of a calling campaign.

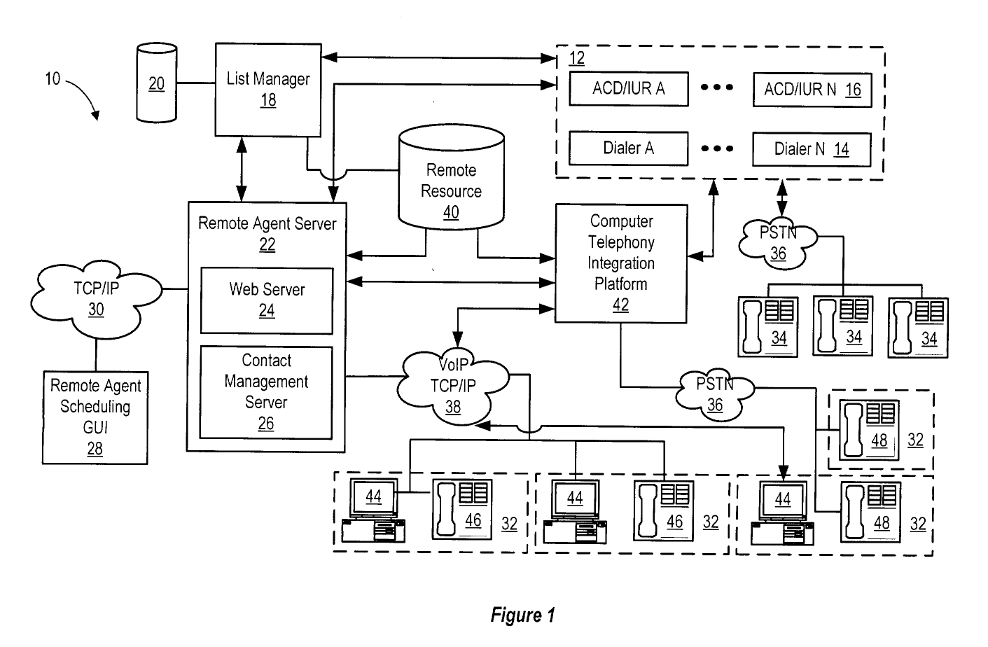

Referring now to FIG. 1, a block diagram depicts a remote dialing and answering system 10 for providing automated dialing and answering functionality to remote agents. Inbound and outbound calls are processed by dialing or answering systems and forwarded with contact information to remote agents for distributed handling. Contact capacity and agent assignments are managed for effective use of contact resources distributed over remote locations.

A set of contact devices 12, including dialers 14 and answering systems 16, provide call dialing and answering functionality. For instance, dialers 14 are predictive dialers that place outbound calls at a rate predicted to provide successful call contacts to operators as the contacts occur so that operators are kept busy. Answering systems 16 are, for instance, automated call distribution devices that answer inbound calls and forward the answered calls to agents as the agents become available. Dialers 14 and answering systems 16 may be distributed geographically, communicating through networks such as the public switched telephone network (PSTN) or the Internet, and may work in concert so that contact resources for dialing and answering calls are used to manage answering wait times and dialing contact objectives. For instance, a set of agents may represent a contact resource for both outbound and inbound calls handled through multiple dialers and/or multiple answering systems based on the contact capacity of each contact device.

Contact devices 12 are in communication with a list manager 18, a list database 20 and a remote agent server 22. List manager 18 and list database 20 perform dual functions of tracking contact resource usage and availability and providing contact lists to contact devices on a timely basis. List manager 18 tracks the contact resources available from contact devices 12 by maintaining lists of scheduled use and availability in list database 20. For instance, for each contact device 12, list manager 18 maintains one or more lists that identify dialing resources available for placing outbound calls, such as schedules of outbound calls, and answering resources for answering inbound calls, such as call statistics, answering resources, and caller wait times. Once contact resources are scheduled, contact devices 12 requests information from lists maintained in list database 20 and accessed through remote agent server 22 and list manager 18. For instance, for an outbound calling campaign, a predictive dialer 14 requests records from list manager 18 at a rate predicted to ensure that live contacts are available when the next remote agent becomes available. Thus list manager 18 communicates with contact devices 12 to manage agent resources logged into remote answering and dialing system 10 and also communicates with remote agent server 22 to manage contact resources.

Remote agent server 22 manages contact device resources to achieve desired goals by coordinating communication between remote agents and contacted individuals once contacts are established by contact devices 12. A Web server 24 accesses contact information for contacted individuals from list manager 18, forwards the contact information to remote agents, such as through the presentation of HTML pop-up screens, and updates list database 20 based on remote agent inputs. A contact management server 26 manages contact resources by presenting contact resource information to a remote agent scheduling Graphical User Interface (GUI) 28 and by coordinating communication of contacts established by contact devices 12 with remote agents.

Contact management server 26 enhances efficient use of contract resources and productivity of remote agents. For instance, a call center administrator interfaces with contact management server 26 through remote agent scheduling agent GUI 28 over a TCP/IP-based network 30, such as a Local Area Network (LAN), Wide Area Network (WAN) or the Internet. The call center administrator determines available contact resources by communication with list manager 18 through contact management server 26 for scheduling inbound and outbound contact resources. To schedule outbound dialing of a call list, dialing resources available from dialers 14 is determined and reserved for the outbound list and the outbound calls are scheduled with list manager 18. List manager 18 schedules contact devices 12 so that inbound and outbound resources are managed most effectively across contact devices 12. To schedule inbound answering, answering resources available from answering devices 16 are determined and reserved with list manager 18. As an example, a calling center administrator expecting an influx of calls may set aside answering resources to manage inbound caller wait times. For both inbound and outbound contacts, the calling administrator may also identify desired remote agents 32 and the contact information for each remote agent 32. List manager 18 maintains a list of remote agents associated with an inbound or outbound contact campaign.

Communication between remote agents 32 and individual contacts 34 are supported through the PSTN 36 and TCP/IP networks 38, such as the Internet, LANs or WANs. For instance, remote agents associated with a contact campaign are identified by each remote agent's IP address or telephone number. Remote agent location, availability, such as the time that a remote agent is scheduled to be on-line and available, and status, such as on-line or offline, are tracked in a remote resources database 40. A computer telephony integration platform 42 communicates with remote resources database 40, contact devices 12 and remote agent server 22 to establish communications between contacts and desired remote agents. For instance, a contact established by a contact device 12 is identified to remote resource database 40 and forwarded from contact device 12 to computer telephone integration platform 42. List manager 18 communicates to remote resources database 40 the remote agents 32 available for handling the contact. Remote agent server 22 references remote resources database 40 to determine the status of the identified remote agents and directs computer telephony integration platform 42 to handle the contact appropriately, such as by forwarding the contact to an available remote agent 32. Thus, computer telephony integration platform 42 acts as a bridge under the direction of remote agent server 22 to connect contacts 34 made through the PSTN 36 and contact devices 12 with remote agents 32 through a computer network 38.

Computer telephony integration platform 42 directs communication between an individual contact 34 and a remote agent 32 by translating telephone signals so that remote agents 32 communicate over computer-based networks with individual contacts 34 connected through telephony devices over the PSTN. For instance, remote agents 34 interfaced with computer telephony integration platform 42 may communicate through a computer system 44 with Voice over IP capability, over an IP phone 46 or through PSTN 36 through analog telephone systems. Once computer telephony integration platform 42 establishes communication between a remote agent 32 and an individual contact 34, the connection is passed to web server 24 of remote agent server 22 so that information about the individual contact is passed to the assigned remote agent 32, such as by pushing an HTML web page to the computer system 44 of remote agent 32. Thus, remote agents 32 may serve individual contacts through a computer system that provides both contact information and a voice connection, or may serve individual contacts with a separate IP or PSTN phone connection and a computer system to display pushed data as pop-up screens.

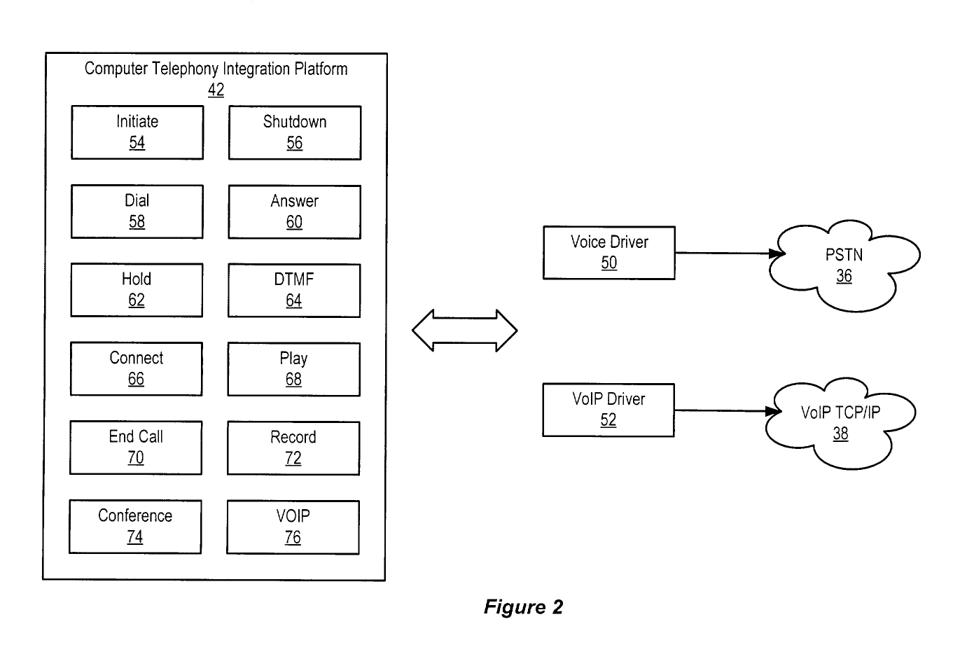

Computer telephony integration platform 42 applies an object oriented design to establish communications between remote agents and individual contacts. Referring now to FIG. 2, a block diagram depicts examples of methods installed as a dynamic link library on computer telephony integration platform 42 to handle call functions defined as properties. Calls with contact individuals are communicated through a voice driver 50, such as the Prosody module available from Aculab, to PSTN 36. Calls with remote agents and related data are communicated through a VoIP driver 52, such the Aculab VoIP module, to a TCP/IP network. Computer telephony integration platform 42 mediates calls established by contact devices 12 to connect contact individuals and remote agents or, in one embodiment, performs contact device functions by placing and receiving calls.

Initiate module 54 and shutdown module 56 perform methods to power up and power down the system, including initiation and completion of establishing network communications. A dial module 58 initiates communication from the platform, such as by dialing a remote agent or outbound caller. An answer module 60 handles calls to the platform, such as when a remote agent reports on line or a contact is forwarded from a contact device 12. The dial module 58 and answer module 60 also support outbound and inbound calls if the computer telephony integration platform performs contact device functions. A hold module 62 places calls on hold, such as to await the availability of a remote agent. A DTMF module 64 accepts touch tone inputs in support of interactive voice response unit functions for inbound calls. A connect module 66 connects calls, such as a contact individual and a remote agent. A play module 68 plays prerecorded messages, such as instructions or messages for holding callers. An end call module 70 tears down calls upon completion. A record module 72 records messages, such as requests for instructions or help from an inbound caller who desires a call back. A conference module 74 supports multiple callers to the same call, such as if a remote agent calls an independent third party to confirm a caller purchase. A VoIP module supports voice over internet protocol inbound and outbound calls.

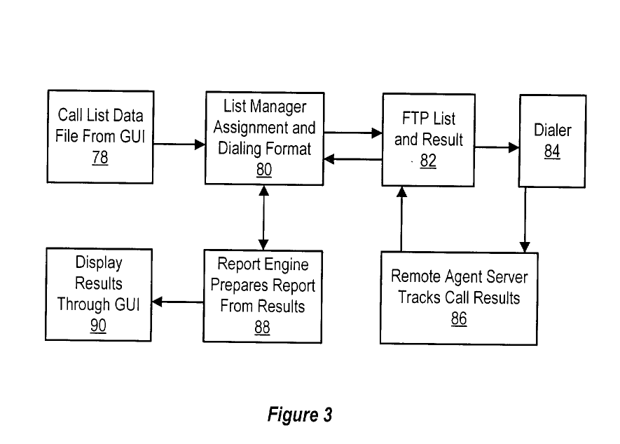

Referring now to FIG. 3, a block diagram depicts the flow of information for initiating an outbound call list and reporting the results from calls made according to the list. At step 78, a call list of individuals to contact is transferred to list manager 18 from remote agent GUI 28. Remote agent GUI 28 may schedule dialing of the calls at a predetermined time or initiate dialing directly. At step 80, list manager 18 assigns the call list to one or more contact devices 12 and formats the call list for the assigned contact device. At step 82, the formatted call list is transferred to the contact device and the remote agents server. At step 84, a dialer contact device calls the list as formatted by list manager 18 and call results for the list are transferred to the remote agent server. At step 86, remote agent server 22 tracks call list results received from remote resources database 40 and computer telephony integration platform 42 and returns the results for the formatted list at step 82. At step 88, the results are compiled by list manager 18 and sent at step 90 to remote agent GUI 28 for display.

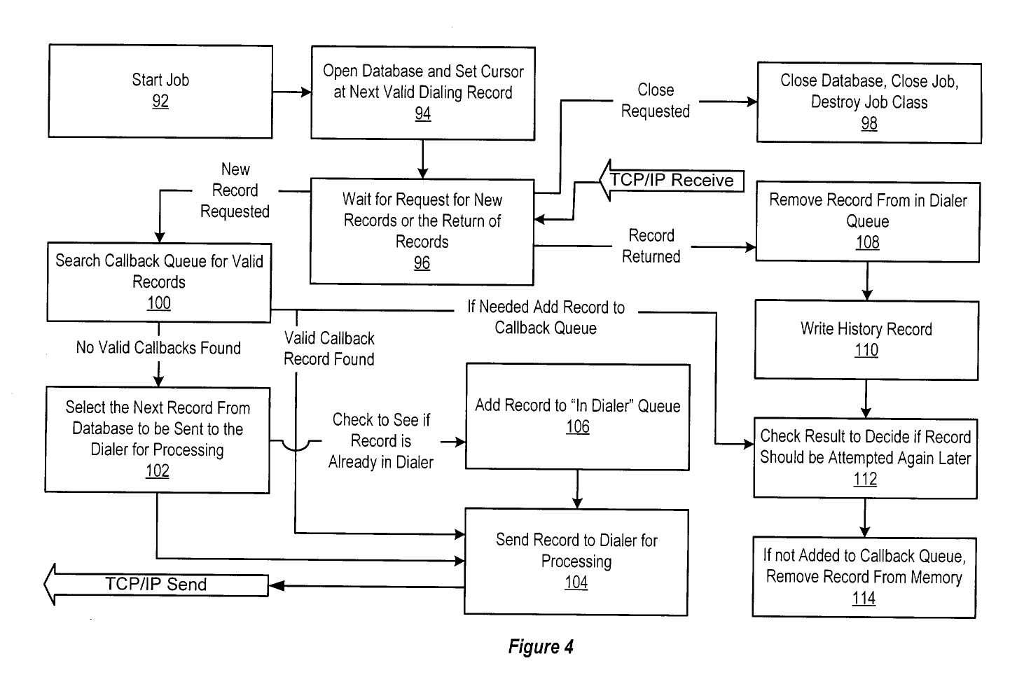

Referring now to FIG. 4, a flow diagram depicts list management data flow for an outbound contact device in greater detail. The process begins at step 92 with a command to start an outbound dialing job, such as at a scheduled time or upon a specific instruction. At step 94, the call list database is opened and the next valid number on the list is set for dialing. At step 96, list manager 18 holds the calling list pending a request for new calling records and also awaits the return of records for completed call attempts. If, at step 96, a request is instead made to close the calling list, then at step 98, remote agent server 22 closes the database, closes the job and destroys the job class and sends a TCP/IP message to list manager 18 to end the job.

If a new record request is received at step 96, the process proceeds to step 100 for a search of a callback queue to determine if the numbers are listed as having call back requests, such as when a contact individual requests a call back at a later time.

Calling records without a valid callback request proceed to step 102 to determine whether the record is in a dialer queue. If the record is not in a dialer queue, then at step 104, the record is sent to the dialer for processing and a TCP/IP message is sent to remote agent server 22 to update the record as sent to the dialer. If at step 102, a determination is made that the record is in a dialer queue, the process proceeds to step 106 to add the record to an in dialer queue and the record proceeds to step 104. This avoids multiple calls to a single number. Returning to step 100, if a callback request is found for a record, a determination is made of whether the callback is valid, such as a callback requested for the current time. If the callback is valid, the record proceeds to step 104. If the callback is not valid, the record proceeds to step 112 to determine whether a callback should be scheduled.

If, at step 96, a record is returned, the process proceeds to step 108 where the returned record is removed from the in dialer queue. At step 110, the record is written to the call history and, at step 112, a determination is made of whether the record should be re-called, such as with a call back request or an answering machine response. If another call attempt is determined, the record is added to the call back queue. If no call back is scheduled, the process proceeds to step 114 where the record is removed from memory to prevent an additional call back attempt.

In operation, the present invention supports the pooling of contact resources by selling entities so that different buying entities may use available contact resources on demand. For example, a calling center with excess outbound dialing capacity rents that excess capacity to plural renters through remote agent scheduling GUI 28. A renting entity schedules outbound contact resources and identifies remote agent addresses for routing voice and data associated with contacts made by the contact device. This arrangement advantageously allows plural renting entities to use excess capacity on an as-available basis, providing more efficient use of contact resources. Further, by pooling excess capacity from several outbound contact resources, a more efficient allocation of outbound calls is made than is available from contact resources allocated on a separate basis.

One important advantage of the present invention is that it allows decentralization of human resources by distributing remote agents geographically from the calling center resources. For instance, the use of public access points, such as colocation facilities and Internet POPs, brings together a cohesive group of resources, even though geographically distributed. Remote agent server 22 provides efficient and timely management and control of remote agent resources and central point of communication for real-time reporting and instant messaging or voice instructions. Decentralization reduces or eliminates requirements for leased lines, such as by using VoIP and Internet data transfers to coordinate voice and data over public facilities in combination with the PSTN.

Although the present invention has been described in detail, it should be understood that various changes, substitutions and alterations can be made hereto without departing from the spirit and scope of the invention as defined by the appended claims.

What is claimed is:

1. A system for distributing contacts from contact devices to remote agents, the system comprising:
one or more contact devices operable to establish contacts through a telephone network by dialing telephone numbers;
a computer telephony integration platform interfaced with the one or more contact devices;
plural geographically distributed remote agent computer systems interfaced with the computer telephony integration platform through a computer network; and
a remote agent server interfaced with the computer telephony integration platform and operable to direct the computer telephony integration platform to connect contacts of the contact devices with predetermined remote agent computer systems over the computer network.

2. The system of claim 1 wherein the computer network comprises the Internet, the computer telephony integration platform connecting contacts with remote agent computer systems with Voice over Internet Protocol.

3. The system of claim 2 wherein the remote agent server is further operable to push contact information associated with a contact to the remote agent computer system.

4. The system of claim 3 wherein the contact devices comprise dialing devices operable to dial outbound telephone calls.

5. The system of claim 1 wherein the contact devices comprise answering devices operable to answer inbound telephone calls.

6. The system of claim 1 further comprising a list manager interfaced with the remote agent server and the contact devices, the list manager maintaining contact lists for the contact devices and operable to forward contact list information formatted for use by the contact devices.

7. The system of claim 6 wherein the list manager is further operable to maintain remote agent lists identifying remote agents associated with a contact campaign.

8. The system of claim 7 wherein the contact campaign comprises an inbound campaign, the remote agent list identifying remote agents associated with responding to predetermined inbound calls to one or more of the contact devices.

9. A method for distributing contacts from one or more contact devices to geographically distributed remote agents, the method comprising:
inputting a list of contacts to a list manager;
scheduling outbound dialing of the list of contacts with the one or more contact devices;
scheduling remote agents to respond to contacts made by the contact devices;
dialing from the list to establish contacts;
forwarding contacts to a computer telephony integration platform;
coordinating connection of contacts with remote agents through a remote agent server interfaced with the computer telephony integration platform, the remote agents communicating with contacts through computer systems interfaced with the computer telephony integration platform through a computer network.

10. The method of claim 9 wherein scheduling outbound dialing further comprises:
determining the available contact resources of the contact devices; and
distributing the list of contacts among plural contact devices according to the determination of the availability of contact resources.

11. The method of claim 10 further comprising:
inputting the call list through a graphical user interface in communication with the remote agent server.

12. The method of claim 9 wherein the remote agents communicate with the computer telephony integration platform with Voice over Internet Protocol.

13. The method of claim 9 wherein the coordinating connection of contacts further comprises pushing contact information associated with contacts from the remote agent server to the remote agent computer systems.

14. The method of claim 13 further comprising:
updating the contact information at the remote agent computer system; and
forwarding the updated contact information to the remote agent server.

15. The method of claim 14 wherein updating the contact information comprises inputting information to an HTML page.

16. A method for managing contact device resources, the method comprising:
interfacing contact resources with a computer telephony integration platform and a remote agent server;
defining contact device resource availability in a list manager, the list manager in communication with the remote agent server;
interfacing with the remote agent server to request contact device resources for a contact list;
assigning contact device resources with the list manager to fill the request;
identifying computer addresses for remote agents interfaced with the computer telephony integration platform; and
applying the contact device for contacts associated with the contact list, the remote agent server and computer telephony integration platform cooperating to connect contacts with remote agents through remote agent computer systems associated with remote agent computer addresses.

17. The method of claim 16 wherein the contact resources comprise outbound dialing resources.

18. The method of claim 16 wherein the contact resources comprise inbound call answering resources.

19. The method of claim 16 further comprising:
providing contact information to the remote server, the contact information associated with contacts of the contact list; and
forwarding contact information associated with a contact to the remote agent connected with the contact.

20. The method of claim 19 further comprising:
inputting at the remote agent computer contact information associated with the contact; and
updating the contact information of the remote agent server with the inputted contact information.

21. A method for allocating contact resources associated with plural contact devices, the method comprising:
interfacing the plural contact devices with a remote agent server;
interfacing the remote agent server with a list of the available contact resources associated with each contact device;
displaying the available contact resources with a Graphical User Interface in communication with the remote agent server; and
assigning with the Graphical User Interface some of the contact resources to forward contacts to predetermined remote agents.

22. The method of claim 21 wherein assigning further comprises renting contact resources by a calling entity from the owner of a contact device.

23. The method of claim 22 wherein the remote agents are associated with the calling entity.

24. The method of claim 23 wherein renting further comprises renting contact resources by a calling entity from plural contact device owners.

25. The method of claim 23 wherein assigning further comprises identifying the remote agents by IP address.

26. The method of claim 22 wherein assigning further comprises renting contact resources by plural calling entities.
